(19) United States
(12) Patent Application Publication
(10) Pub. No.: US 2002/0155770 A1
(43) Pub. Date: Oct. 24, 2002

(54) Liquid roofing

(76) Inventor: Pieter Wynand LeRoux Van Niekerk, Pretoria (ZA)

Correspondence Address: HESLIN ROTHENBERG FARLEY & MESITI PC, 5 COLUMBIA CIRCLE, ALBANY, NY, 12203, US

(21) Appl. No.: 09/841,059

(22) Filed: Apr. 23, 2001

(51) Int. Cl. B32B 3/00; D04H 1/00

(52) U.S. Cl. 442/59; 442/417

(57) ABSTRACT

The invention relates to roofing systems and methods wherein a coating composition including a fibrous material and a first polymer emulsion is applied over a roofing substrate; a rubber composition including rubber granules and a second polymer emulsion may be applied directly to the roofing substrate before the coating composition is applied. The first and second polymer emulsions are preferably (meth)acrylate ester polymer emulsions, which may have different compositions, the rubber granules are preferably obtained from rubber used in the manufacture of used vehicle tires, and the fibrous material is preferably polyamide fibers.

### FIELD OF THE INVENTION

The invention relates to roofing systems which include at least one layer of a coating composition comprising a fibrous material and a polymer composition, disposed over a roofing substrate, such as shingles or a wooden substrate.

### BACKGROUND OF THE INVENTION

It is general practice in the United States and Canada for roofs to be constructed of a plywood or pressed wood substrate covered by strips of shingles which overlay each other. This arrangement is shown in FIG. 1. Over a period of time, shingles become weathered, and are chemically degraded by exposure to ultraviolet light. As a result, shingles can become brittle and inflexible, and may be blown off during severe storms. In addition, the ends of the weathered shingles can absorb water; when the water freezes in cold weather, the tips of the shingles may break off. By either of these mechanisms, the wooden substrate of the roof may be exposed, and the structure becomes vulnerable to water damage, and consequent costly repairs. There is, therefore, a need for a means of protecting shingles that have been installed on a roof from weathering.

### SUMMARY OF THE INVENTION

In one aspect, the present invention relates to a roofing method comprising applying, to a roofing substrate, a coating composition comprising a fibrous material and a first polymer emulsion. A rubber composition comprising rubber granules and a second polymer emulsion may be applied directly to the roofing substrate, before applying the coating composition. The first polymer emulsion is preferably a (meth)acrylate ester polymer emulsion, and the fibrous material is preferably polyamide fibers. The second polymer emulsion is preferably a (meth)acrylate ester polymer emulsion, and the rubber granules are preferably obtained from rubber used in the manufacture of vehicle tires, particularly used vehicle tires.

In another aspect, the present invention relates to a roofing system comprising a roofing substrate and at least one layer of a coating composition comprising a fibrous material and a first polymer composition, and disposed over the roofing substrate. The roofing system may additionally include at least one layer of a rubber composition comprising rubber granules and a second polymer composition, and disposed directly on the roofing substrate. In one embodiment, the roofing substrate may be wood, particularly, a stepped wooden substrate. In another embodiment, the roofing substrate may be asphalt shingles.

### BRIEF DESCRIPTION OF THE DRAWINGS

FIG. 1 shows a standard roofing system, commonly used in the United States and Canada.

FIG. 2 illustrates a roofing system according to the present invention, including a first layer of a rubber composition and a second layer of a coating composition applied over an asphalt shingle substrate.

FIG. 3 shows a roofing system according to another embodiment of the present invention, wherein the first and second layers are applied to unstepped wooden substrate.

FIG. 4 shows a roofing system according to yet another embodiment of the present invention, wherein the first and second layers are applied to a stepped wooden substrate, and simulate the appearance of roofing tiles.

### DETAILED DESCRIPTION OF THE INVENTION

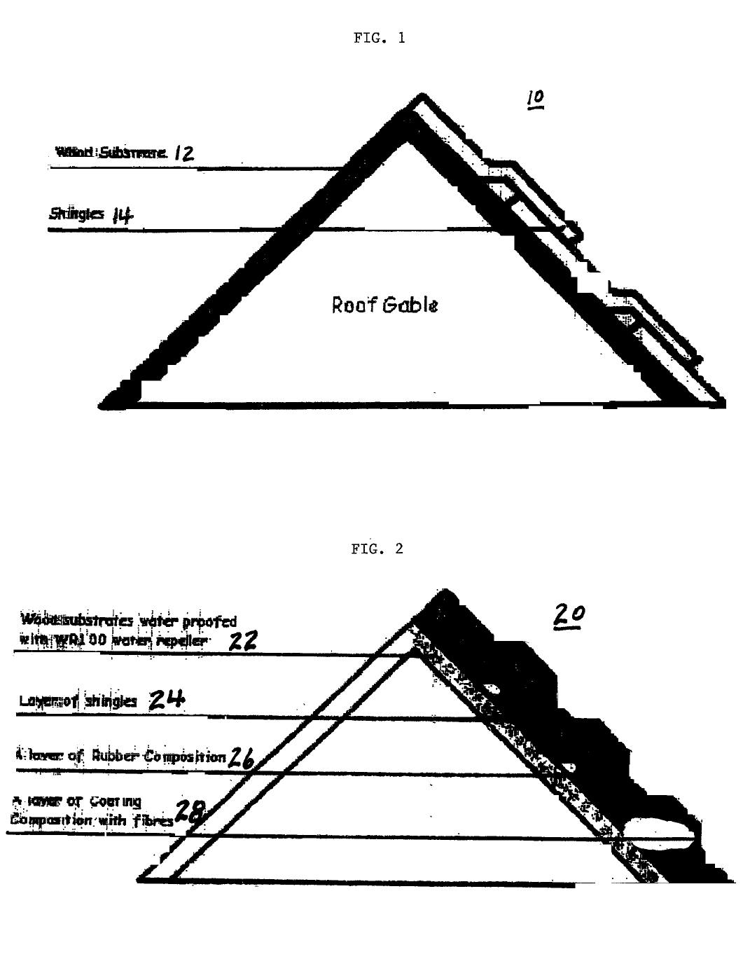

With reference to the drawings, FIG. 1 shows a roof gable 10 covered with a standard roofing system as commonly used in the United States and Canada. A wooden substrate 12 is covered with a layer 14 of overlapping asphalt shingles. FIG. 2 shows a roof gable 20 covered with a roofing system according to the present invention. A wooden substrate 22, typically waterproofed with a water repellant composition, is covered with a layer 24 of overlapping asphalt shingles. Shingle layer 24 is coated with a first layer 26 composed of a rubber composition, and a second layer 28 is applied to first layer 26. Both the first and second layers, 26 and 28, may be made up of multiple coats. If desired, first layer 26 may be omitted entirely (not shown).

The coating composition comprises a fibrous material and a first polymer emulsion. The first polymer emulsion is a film-forming polymer at temperatures as low as 6-10° C.; the emulsion may contain additives such as plasticizers in order to facilitate film formation. The polymer may be a homopolymer or copolymer derived from one or more (meth)acrylate esters, vinyl acetate, styrene, or combinations thereof. In particular, the first polymer emulsion may be derived from one or more (meth)acrylate ester monomers. In this context, the term (meth)acrylate is intended to include acrylate and methacrylate. The fibrous materials may be organic or inorganic fibers, such as glass, steel, carbon, asbestos, aramide, polypropylene, polyvinyl alcohol, polyester, polyamide or polyacrylate fibers, and, in particular, polyamide fibers. The fibers have a thickness from about 5 microns to about 40 microns, preferably from about 10 microns to about 30 microns, and have a length from about 0.5 millimeters to about 4 millimeters, preferably from about 1 millimeter to about 3 millimeters. The concentration of the fibers in the coating composition ranges from about 10 grams to about 50 grams per liter, and preferably from about 15 grams to about 40 grams per liter.

The rubber composition comprises rubber granules and a second polymer emulsion. The second polymer emulsion may be a synthetic latex or a blend of a synthetic latex with a natural latex. Natural latex, in this context, means a natural rubber latex. The synthetic latex is typically an aqueous emulsion or dispersion of a homopolymer or a copolymer having a T_{g} below room temperature, or less than about 20° C. The homopolymer or copolymer may be derived from one or more (meth)acrylate ester monomers, vinyl acetate, styrene, or combinations thereof. In particular, the polymer may be a copolymer of an acrylate ester. The polymer may be emulsified in situ, as during an emulsion polymerization process, or may be post-emulsified.

The rubber granules may be any type of rubber, and may, especially, be derived from rubber used in the manufacture of tires, and preferably, from used tires. The particle size of the rubber granules is less than 1 mm, and preferably less than 400 μm. The amount of rubber granules present in the rubber composition is typically at least 70 g per liter of polymer emulsion, and, in particular, ranges from about 125 g to 200 g per liter. The addition of a surfactant to the rubber composition may be desirable in order to reduce settling and/or flocculation of the rubber granules, and so, to increase shelf life of the composition.

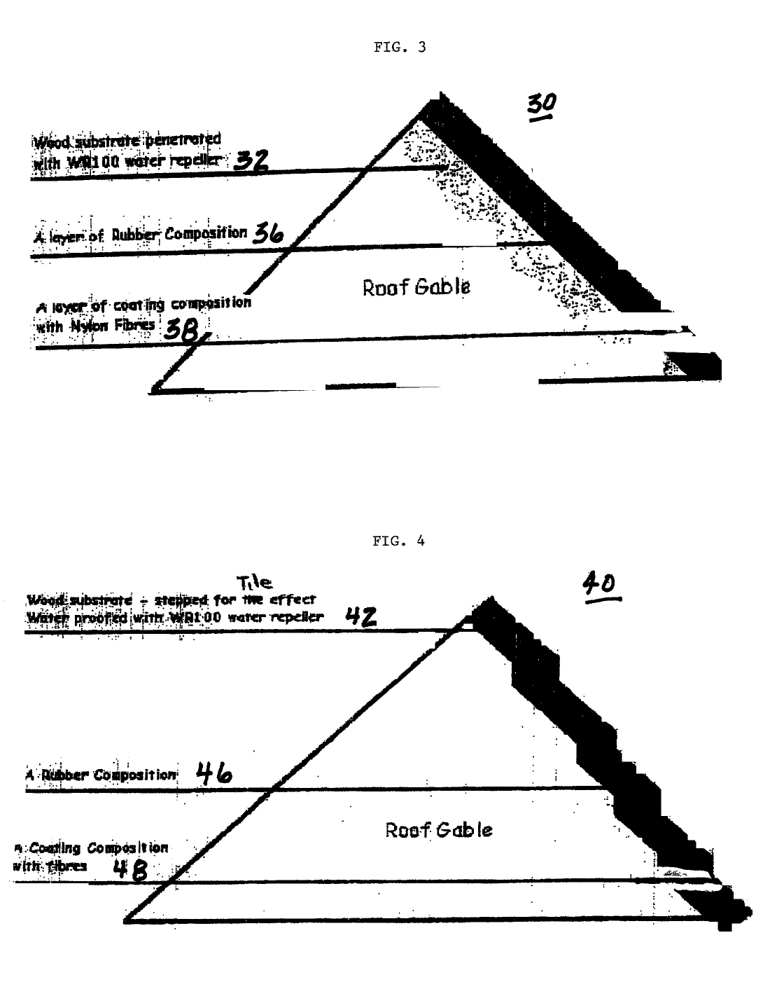

In another embodiment, the present invention relates to a roofing system shown in FIGS. 3 and 4. FIG. 3 depicts a roof gable 30 having a standard unstepped wooden substrate 32, and FIG. 4 shows a roofing gable 40 having a wooden substrate 42 stepped to simulate the appearance of tiles. In these embodiments, a first layer (36/46) comprising a rubber composition is applied directly to the wooden substrate (32/42) and a second layer (38/48) is applied to the first layer. As for the roofing system depicted in FIG. 2, the layer composed of the rubber composition may be omitted, if desired, and the coating composition applied directly to the roofing substrate. Also, the first and/or the second layers are typically made up of multiple coats.

For the embodiments shown in FIGS. 3 and 4, a significant cost savings may be obtained, as no shingles are used. In addition the roofing system is more durable, as the coating composition, containing fibers, adheres directly to the rubber composition; in embodiments where the coating composition is applied to a shingle layer, the durability of the layer can be dependent on the adhesion of the shingles to the substrate. Finally, the roof has the appearance of a thicker tile, at no additional cost.

The present invention also relates to a roofing method comprising applying, to a roofing substrate, one or more coats of the coating composition described above. The coating composition alone may be used over the roofing substrate, or, if desired, the method may additionally include applying the rubber composition described above to the roofing substrate, before applying the coating composition. The roofing substrate may be wood, including a stepped wooden substrate, cement, or metal. The coating and rubber compositions are easily applied by spraying or by means of a brush. Where a spray applicator is used, it has been found that the coating composition does not clog nozzles of small diameter. Once applied and dried, the polyamide fibers in the coating have been found to have formed a substantially uniform weave within the acrylic emulsion. This provides the composition with strength, high impact resistance and flexibility over an extended period of time, and results in a more cost effective and durable coating than prior art equivalents. The coating composition remains workable and retains its favorable properties with fibers having a thickness is in the range from 5 to 40 microns, approximately, and whose length is from about 0.5 millimeters to about 4 millimeters. Fibers with a length exceeding 4 millimeters cause the composition to become stringy and to clog spray application equipment. Further, the concentration of the polyamide fibers in the acrylic emulsion will result in a coating with an even appearance, while the low oil absorption characteristics ensure that the gloss of the coating is not adversely effected.

The rubber composition is easily applied by means of a brush or spray applicator and dries fairly quickly. Where a spray applicator is used, the spray nozzle needs to be modified, usually by enlarging the nozzle diameter, to prevent clogging. With rubber granules forming up to approximately 30% weight/weight of the mixture, the mixture has a relatively low viscosity and can easily be applied using a spray applicator. At higher loadings, the viscosity increases and it becomes necessary to use a brush or to pour the mixture onto a surface and spread it with a scraper. The rubber granules provide an advantage in that they replace the water used in standard formulations and give a notable increase in volume solids of about 30% in the dry film, improved dry coat thickness, and a cost reduction of about 25%.

### EXAMPLES

### Example 1

A flowable rubber composition suitable for application as the first layer was produced by mixing rubber granules obtained from used tires with a latex such that the rubber comprises 40% weight/weight of the composition. The granules were smaller than 400 μm (approximately 40 mesh) and were obtained by skimming rubber off used tires. The latex used was a blend of a pure acrylic synthetic latex and a stryrene acrylic synthetic latex. The rubber granules were mixed with a wetting agent sold as “Dacxad” prior to adding to the polymer emulsion, and then added under slow stirring until a homogeneous mixture was obtained.

### Example 2

A flowable coating composition was produced by mixing polyamide fibers with an acrylic emulsion such that the concentration of polyamide fibers was approximately 40 grams per liter of emulsion. The polyamide fibers are available under the well known trade names “Perlon” or “Nylon.” The polymide fibers have a length of about 3 millimeters and a diameter of approximately 30 microns.

1. A roofing method comprising:
applying, to a roofing substrate, a coating composition comprising a fibrous material and a first polymer emulsion.

2. A roofing method according to claim 1, additionally comprising applying a rubber composition comprising rubber granules and a second polymer emulsion to the roofing substrate, before applying the coating composition.

3. A roofing method according to claim 1, wherein the roofing substrate comprises wood.

4. A roofing method according to claim 3, wherein the roofing substrate is a stepped wooden substrate.

5. A roofing method according to claim 1, wherein the roofing substrate comprises asphalt shingles.

6. A roofing method according to claim 2, wherein the second polymer emulsion comprises an acrylic polymer emulsion.

7. A roofing method according to claim 6, wherein the second polymer emulsion comprises a styrene/acrylate ester copolymer emulsion.

8. A roofing method according to claim 2, wherein the rubber granules are obtained from rubber used in the manufacture of vehicle tires.

9. A roofing method according to claim 8, wherein the vehicle tires are used tires.

10. A roofing method according to claim 1, wherein the rubber granules are smaller than one millimeter.

11. A roofing method according to claim 10, wherein the rubber granules are smaller than 400 μm.

12. A roofing method according to claim 2, wherein the rubber composition comprises at least 70 g rubber granules per liter of the second polymer emulsion.

13. A roofing method according to claim 12, wherein the rubber composition comprises between 125 g and 200 g rubber granules per liter of the second polymer emulsion.

14. A roofing method according to claim 1, wherein the first polymer emulsion comprises a polymer comprising units derived from one or more acrylate or methacrylate ester monomers.

15. A roofing method according to claim 1, wherein the fibrous material comprises polyamide fibers.

16. A roofing method according to claim 15, wherein the concentration of polyamide fibers ranges from about 10 grams to about 50 grams per liter of the first polymer emulsion.

17. A roofing method according to claim 16, wherein the concentration of polyamide fibers ranges from about 15 grams to about 40 grams per liter of the first polymer emulsion.

18. A roofing method according to claim 2, wherein the fibrous material comprises polyamide fibers, the first polymer emulsion comprises a first polymer comprising units derived from one or more acrylate or methacrylate ester monomers, and the second polymer emulsion comprises a second polymer comprising units derived from one or more acrylate or methacrylate ester monomers.

19. A roofing system comprising:
a roofing substrate and at least one layer of a coating composition comprising a fibrous material and a first polymer composition, and disposed over the roofing substrate.

20. A roofing system according to claim 19, additionally comprising at least one layer of a rubber composition comprising rubber granules and a second polymer composition, and disposed directly on the roofing substrate.

21. A roofing system according to claim 19, wherein the roofing substrate comprises wood.

22. A roofing system according to claim 21, wherein the roofing substrate is a stepped wooden substrate.

23. A roofing system according to claim 19, wherein the roofing the substrate comprises asphalt shingles.

24. A roofing system according to claim 20, wherein the second polymer composition comprises a synthetic polymer.

25. A roofing system according to claim 24, wherein the second polymer composition comprises a blend of synthetic and natural polymers.

26. A roofing system according to claim 24, wherein the synthetic polymer is a polymer comprising units derived from one or more acrylate or methacrylate ester monomers.

27. A roofing system according to claim 26, wherein the synthetic polymer is a copolymer comprising units derived from styrene and one or more acrylate or methacrylate ester monomers.

28. A roofing system according to claim 20, wherein the rubber granules are obtained from rubber used in the manufacture of vehicle tires.

29. A roofing system according to claim 28, wherein the vehicle tires are used tires.

30. A roofing system according to claim 20, wherein the rubber granules are smaller than one millimeter.

31. A roofing system according to claim 30, wherein the rubber granules are smaller than 400 μm.

32. A roofing system according to claim 20, wherein the rubber composition comprises at least 70 g rubber granules per liter of the second polymer emulsion.

33. A roofing system according to claim 32, wherein the rubber composition comprises between 125 g and 200 g rubber granules per liter of the second polymer emulsion.

34. A roofing system according to claim 20, wherein the first polymer composition comprises a polymer comprising units derived from one or more acrylate or methacrylate ester monomers.

35. A roofing system according to claim 20, wherein the fibrous material comprises polyamide fibers.

36. A roofing system according to claim 20, wherein the first polymer composition comprises a polymer comprising units derived from one or more acrylate or methacrylate ester monomers.
